(19) United States
(12) Patent Application Publication
(10) Pub. No.: US 2014/0082775 A1
(43) Pub. Date: Mar. 20, 2014

(54) Modular UHV Compatible Angle Physical Contact Fiber Connection for Transferable Fiber Interferometer Type Dynamic Force Microscope Head

(71) Applicant: Brookhaven Science Associates, LLC, Upton, NY (US)

(72) Inventor: Percy Zahl, Rocky Point, NY (US)

(73) Assignee: Brookhaven Science Associates, LLC, Upton, NY (US)

(21) Appl. No.: 14/029,168

(22) Filed: Sep. 17, 2013

Related U.S. Application Data
(60) Provisional application No. 61/702,598, filed on Sep. 18, 2012.

(51) Int. Cl. G01Q 20/02

(52) U.S. Cl. CPC G01Q 20/02
USPC 850/6; 29/428

(57) ABSTRACT

A modular transferable ultra-high vacuum compatible device has a body with a tunnel through its thickness. An interferometric sensor is mounted above the body and has a brace on which a cantilever is disposed and through which an optical fiber passes so that the two may be aligned prior to installation in an atomic force measurement apparatus. The sensor-mounted body is coupled to a mount for engaging an atomic force measurement apparatus to act as the interferometric head of the apparatus.

This application claims priority to U.S. Provisional Patent Application Ser. No. 61/702,598, filed on Sep. 18, 2012, the disclosures of which are incorporated by reference into this disclosure in their entirety.

This invention was made with Government support under contract number DE-AC02-98CH10886, awarded by the U.S. Department of Energy. The Government has certain rights in the invention.

### FIELD OF THE INVENTION

This present invention relates to modular integration mounts for atomic force and other scanning probe microscopes. The modular integration mounts permit the ready exchange of customizable or pre-aligned fiber interferometer-type based dynamic force microscope (DFM) heads. In particular, the modular integration capabilities can avoid breaking the ultra-high vacuum (UHV) when required for the particular application.

### BACKGROUND OF THE RELATED ART

Atomic force microscopy (AFM), scanning force microscopy (SFM)/scanning probe microscopy (SPM) involves the measure of interactions between a sample and a sharp tip mounted to a cantilever. The goal of AFM is to provide an image of extremely small samples, usually in the range of nanometers to atomic particle sizes. AFM design was initially described in U.S. Pat. Nos. 4,343,993 and 4,724,318, the entire disclosures of which are incorporated by reference in this disclosure. The movement of the cantilever based on its proximity to a charged sample may be digitally converted into an image of the sample topography under investigation. Exemplary AFM cantilevers may be of the types disclosed in U.S. Pat. Nos. 5,018,865; 5,051,379; 5,274,230; 5,289,004; 5,291,775; 5,354,985; 5,705,814 the entire disclosures of which are incorporated by reference in this disclosure.

Fundamental to the measurement techniques of non-contact AFM devices, such as for example dynamic force microscopes (DFM), are the forces between the atomically sharp tip and the surface or molecules or atoms on the surface of a sample. In dynamic modes, the top oscillates with a very small mechanical amplitude and the oscillation is disturbed by slight changes of the potential, such as when the tip interacts with atoms of the surface or the tip feels the vicinities of other atoms in a non-contact mode. These interactions cause slight shifts of the free oscillation frequency and can be detected with dedicated electronics. In particular, an optical interferometer can be used to measure the oscillation or tip motions so that the exact oscillation amplitude and frequency can be detected.

In addition, tip detection of tunnel currents may be accompanied by the addition of more complicated and mixed detection schemes. Tunnel currents exist in nanometric proximities between a tip of an AFM cantilever working in a combined mode and the sample. Deflections in the cantilever due to tunnel currents between electrons of the cantilever tip and the sample may be measured and mathematically and digitally converted into images of the point on the sample where such deflections took place. The concepts behind AFM measurement are known to those skilled in the art and are further discussed in U.S. Pat. No. 5,003,815, the disclosure of which is incorporated by reference in this disclosure.

Fiber and interferometric DFM/AFM is an advantageous detection method for measuring absolute and direct deflections and amplitudes of a cantilever via the interferometer. As a result, DFM/AFM apparatus handle high frequency vibration and oscillation activities at the cantilever pin and permit high-speed scans of samples.

To enhance the resolution of atomic measurement, AFM cantilevers may be mechanically driven to vibrate, usually at amplitudes on the order of angstroms (Å), such as, for example 1-100 Å, so that the frequency of the cantilever vibration approaches the cantilever resonance frequency (f). A source of mechanical vibration or oscillation of an exemplary. AFM cantilever may be piezoelectric transducers. In this type of AFM, the presence of a force derivative may shift the resonance frequency (f₀) thereby changing one or more of the amplitude or phase of vibration. Using tunnel probes, capacitive measurement systems, or optical measuring systems, cantilever deflection may be detected and digitally recorded and imaged. These and other AFM cantilever displacement measurement technologies may be found in more detail in Rugar et al., Improved fiberoptic interferometer for atomic force microscopy, 55 Appl. Phys. Lett. 2588 (December 1989) the disclosure of which is incorporated by reference in this specification.

Typically an interferometer may be used to measure the light waves of the sample and cantilever during scanning of a sample using an AFM cantilever. An optical fiber interferometer may include mechanisms to emit and receive light traveling through an optical fiber located proximal to the cantilever or cantilever tip. An exemplary optical fiber interferometer known to those skilled in the art may be of the type disclosed in U.S. Pat. No. 5,289,004 or those described in Rugar et al., Improved fiberoptic interferometer for atomic force microscopy, 55 Appl. Phys. Lett. 2588 (December 1989), the disclosures of which are incorporated by reference in its entirety in this disclosure.

The structure that includes the AFM cantilever and measuring sources is generally referred to as an AFM head. When the particular AFM is used as a DFM, this component is also referred to as a DFM head. An exemplary type of atomic force microscope head may be of the type described in Lu et al., An atomic force microscope head designed for nanometrology 18 Meas. Sci. Technol. 1735-1739 (2007), the disclosure of which is incorporated by reference in this disclosure in its entirety.

Before a sample can be scanned, a great deal of precise adjustment and handling are usually required in AFM/DFM measuring procedures. For example, optical fiber proximity to the cantilever may require delicate handling so as to properly read cantilever oscillations during a scan. Alternatively, pre-requisition or instrument/detector alignments may involve cantilever/tip to fiber alignment and interferometer gap (optical fiber end-to-cantilever) pre-adjustments. Cantilever placement and orientation about the sample is another preparatory step to be undertaken. The precise location of the cantilever and tip is required so that adequate forces between the tip and the surface of atoms/molecules can create deflections, de-tuning, and/or dampening of tip oscillations, allowing recordation/enhanced detection by the optical fiber interferometer. These signals are converted into frequency shift (relative to the free oscillation) and are used as input signals for feedback loop to control the tip height above the surface. One way this feedback control is accomplished is by maintaining a fixed frequency shift and regulating the cantilever tip height “Z”. When the surface is scanned over the tip and “Z” is recorded, a topography map can be recorded and visualized through use of suitable computer software configured to graphically render the results obtained. Exemplary feedback control mechanisms are described in Noncontact Atomic Force Microscopy by Morita, Giessibl and Wiesendanger, Vol. 2 (1st Ed. 2009), the disclosure of which is incorporated by reference in this application in their entirety.

Those skilled in the art may recognize that in adjusting for any one of the aforementioned metrics, subsequent adjustment for the remaining metrics may be required. Thus, there is presently a need for overcoming cumbersome, iterative preparations required to utilize of the state-of-the-art AFM/DFM apparatus.

Critical to optimized measurements of samples using AFM techniques is isolation from extrinsic electrical noise and atmospheric disturbances in the oscillating regions of the cantilever, tip, and sample. For this, it is known to use AFM measurement techniques in ultra-high vacuums (UHV) and at low temperatures (LT) as is discussed, for example, in Schwarz et al., Dynamic force microscopy with atomic resolution at low temperatures, 188 App. Surf. Sci. 245-251 (2002), the disclosure of which is incorporated by reference in its entirety in this disclosure. It is not uncommon that large lead times are necessary before AFM scanning can be begun due, in part, to the need for preparation of the mechanisms to induce UHV and LT.

Commonly, a replacement or repositioning of the cantilever, cantilever tip, sample, and/or optical fiber may require reinstitution of the UHV and require longer times between scanning procedures. Current AFM measurement technologies allow for replacement components to be transferred to and from the measurement site by way of compartmentalized vacuum chamber arrays. However, the process of users navigating individual parts along the vacuum chamber arrays for slight adjustments and replacement of components is wasteful and reduces the amount of effective AFM measurements that may take place in a given period of time.

Fiber alignment in UHV is particularly burdensome because of the need for complicated alignment actuators in the UHV. Typically a fiber is fixed within the measurement apparatus and a dedicated alignment between the cantilever and fiber is necessary for every cantilever exchange. To undertake this task, translation actuators designed specifically for the dedicated alignment are required along with optical/visual controllers. This is further complicated due to limited visibility of the fiber and cantilever while in situ. To extract the fiber and cantilever set-up to properly align the fiber may lead to forfeiture of an established UHV.

Therefore, there is a need to facilitate AFM head adjustments in a way that avoids sacrificing the UHV, and minimizes the need to make these adjustments.

### SUMMARY

A modular UHV-compatible fiber connector for a transferrable fiber interferometer-type AFM/DFM head is provided to allow ex situ alignment of the cantilever, optical fiber, or both.

In one example, to avoid sacrifice of UHV during AFM/DFM measurements, the modular UHV compatible fiber connector for a transferrable fiber interferometer-type DFM head may be aligned ex situ to avoid alignment of the cantilever, optical fiber, or both under UHV.

An exemplary transferable modular DFM head assembly comprises a customizable mount for holding a body having a tunnel through which a fiber may pass for alignment with a cantilever-type interferometer. The mount is shaped to slidingly engage a DFM device or allow for vertical placement of a modular transferable DFM head assembly in a microscope column.

Adjustment elements disposed about the modular transferable DFM head assembly may be used to pre-align or realign one of the cantilever, the fiber, or the cantilever and fiber together. An exemplary type of alignment element may be a screw, a piezoelectric actuator, or a combination of the two.

A modular transferable DFM head assembly may be preconfigured for use in particular DFM/AFM applications without resort to UHV disturbance to prepare fiber or cantilever for measurements.

A modular fiber connector device is characterized by a body having a tunnel extending through its thickness and an interferometric sensor assembly located above the body. The interferometric sensor assembly has a brace extending outwardly from the body and having a pair of jaws through which an optical fiber extends from its position in the tunnel of the body. The modular fiber connector also has a cantilever extending from the interferometric sensor assembly and extending over the opening formed by the jaws of the brace. The cantilever can be pre-aligned or aligned with the optical fiber passing through the opening formed by the jaws of the brace. The connector further has a mount that allows the fiber of the modular device to operate with the fiber of an atomic force measurement device to allow for measuring of atomic forces.

The brace of the modular fiber connector may hold the fiber and be aligned with the cantilever using screws on the brace or piezoelectric controls located adjacent to the interferometric sensor assembly. The module fiber connector may have a sleeve coupled to the tunnel through which the fiber of the module device travels. The mount of the modular device is configured to attach to the atomic force measurement device using screws, ball-and-spring mechanisms, or frictional engagements.

A method of installing a modular fiber connector involves aligning a first end of a first optical fiber with a cantilever. The first end of the first optical fiber extends through an opening in a sensor assembly located above a body and a second end of the first optical fiber passing through a tunnel in the body. The cantilever extends from the sensor assembly and extends over the opening through which the first optical fiber extends. The method further involves configuring the body for insertion into a microscope so that the second end of the first optical fiber operatively connects to a second optical fiber coupled to the microscope. The body may thereafter be inserted into the microscope so that the second end of the first optical fiber operatively connects to the second optical fiber coupled to the microscope.

The aligning step of the method further involves adjusting a brace that is coupled to the sensor assembly to displace either the cantilever or the first optical fiber. Fine pre-alignment is done by rotating adjustment screws. Final interferometer operation point adjustment is done via a single piezoelectric transducer.

To configure the body for insertion into a microscope, the device may have a mount coupled to the body for inserting into a microscope. The mount may be configured for sliding engagement of the body into the microscope. The mount may also be configured for the vertical insertion of the body into the microscope.

Alternatively, to configure the device for insertion in a microscope, a sleeve may be placed over the second end of the first optical fiber.

### DESCRIPTION OF THE DRAWINGS

FIG. 1 illustrates a side view of an exemplary embodiment of a modular angle physical contact fiber connector for transferrable fiber interferometer AFM/DFM head.

FIG. 2 illustrates a top plan view of an exemplary embodiment of a modular angle physical contact fiber connector for transferrable fiber interferometer AFM/DFM head.

FIGS. 3A and 3B illustrate isometric views of an exemplary embodiment of a modular angle physical contact fiber connector for transferrable fiber interferometer AFM/DFM head.

FIG. 4 illustrates an enlarged sectioned isometric view of a modular angle physical contact fiber connector for transferrable fiber interferometer AFM/DFM head.

FIG. 5 illustrates an isometric view of a base for insertion of an exemplary modular angle physical contact fiber connector for transferrable fiber interferometer AFM/DFM head.

FIG. 6 illustrates a sectioned isometric side view of a base for insertion of an exemplary modular angle physical contact fiber connector for transferrable fiber interferometer AFM/DFM head.

FIG. 7 illustrates an isometric view of an exemplary modular UHV compatible angle physical contact fiber connector for transferrable fiber interferometer AFM/DFM head inserted into an exemplary base.

In the drawings, like characters of reference numerals indicate corresponding parts in the different figures.

### DETAILED DESCRIPTION

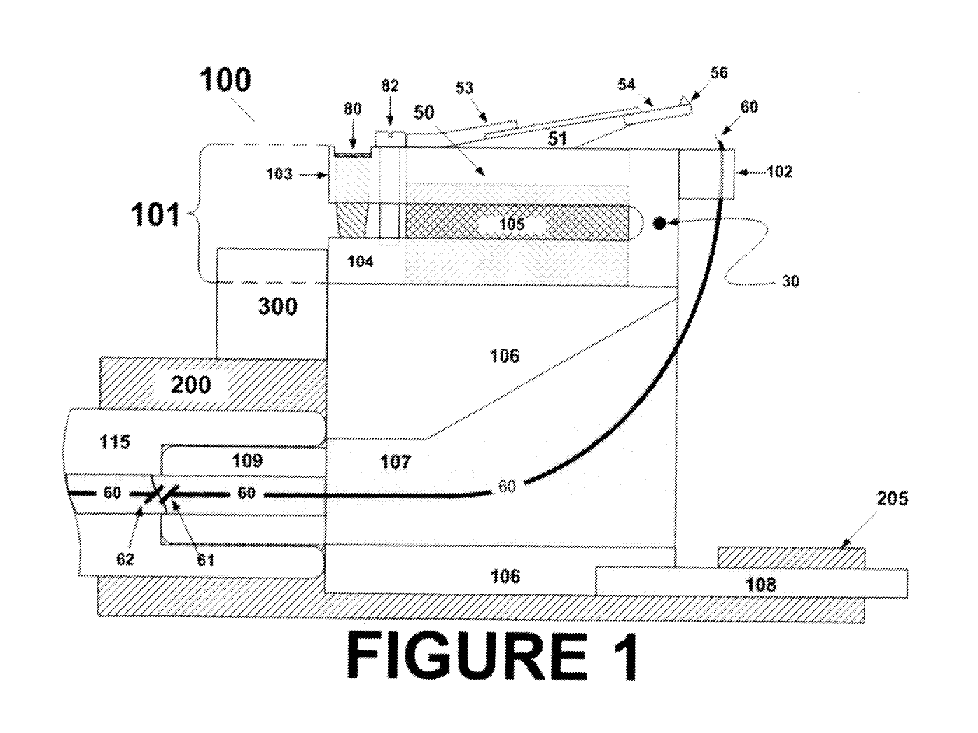

According to the illustrative embodiment of FIG. 1, an exemplary modular UHV compatible angle physical contact fiber connector DFM head 100 may have a sensor assembly 101, tunneled body 106 including tunnel 107, mount 108, and floating alignment sleeve 109. As structured, sleeve 109 provides sliding engagement between connector head 100 and the remainder of DFM base 200. While the modular, transferrable head 100 may slide into a modified (DMI industry standard) APC fiber connector (construct 200), persons skilled in the art would understand that the location of sleeve 109 may be configured to engage vertically accessible columns for magnetic force microscopes as well as other vertically accessible column AFM devices.

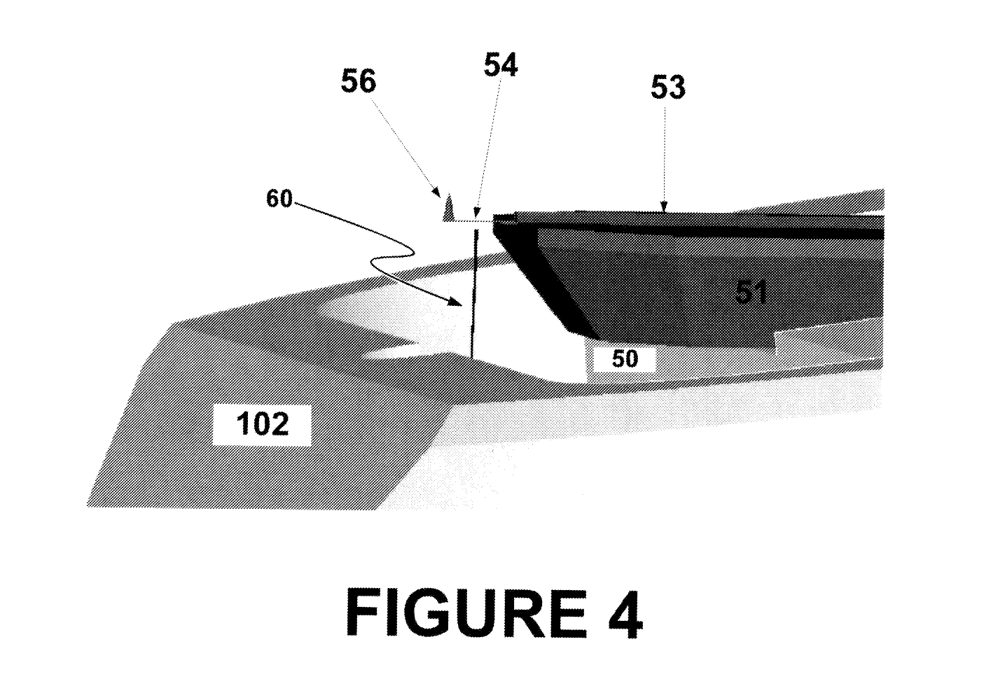

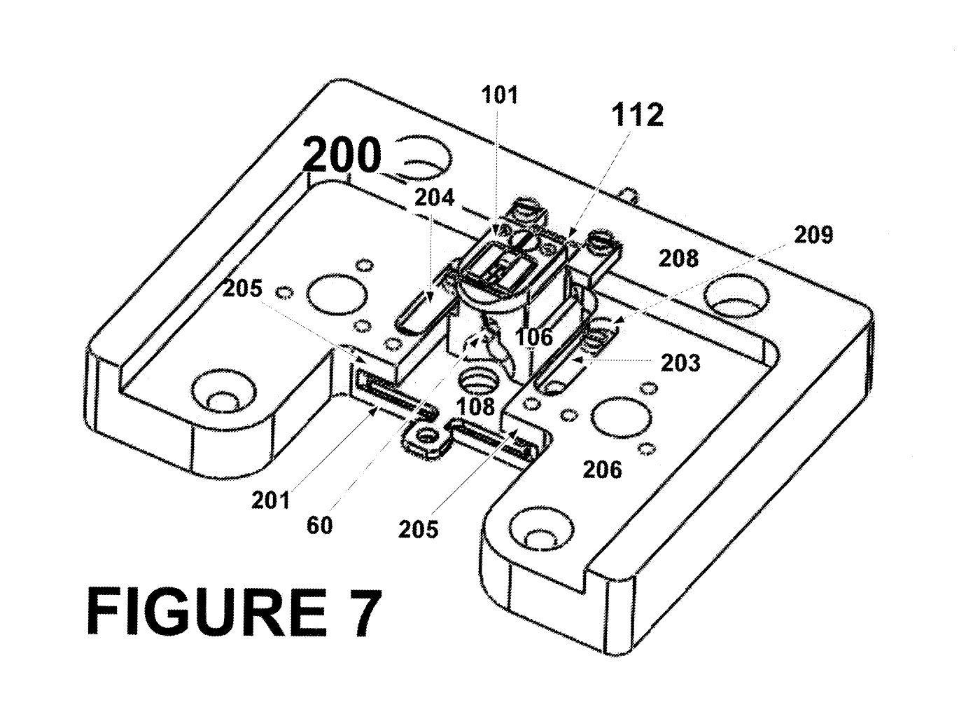

Passing through modular DFM head 100 is fiber 60 from which measurement of oscillation and vibration of cantilever beam 54 and cantilever tip 56 is recorded. In an exemplary embodiment, fiber 60 is comprised of one or more conductive fibers for processing disturbances at the cantilever section while a fully assembled DFM is in operation using the exemplary head 100 (see, for example, FIG. 7). In a preferred embodiment, fiber 60 is coated by a polyimide fiber. From fiber connection sleeve 109, fiber 60 passes through tunnel 107 of body 106 and is bent to rest at the jaw 102 coupled to sensor assembly 101. Fiber 60 may be affixed to jaw 102 using epoxies and other polymer joining compounds known to those skilled in the art. The placement of fiber 60 on jaw 20 may be accomplished using optical microscopic placements which are also known to those skilled in the art. Such placements may be contingent on the location and measuring needs of cantilever 54 and pin 56. As illustrated in FIGS. 1 and 4, the end of fiber 60 in close proximity to cantilever 54 may be a core that is situated within a plurality of outer coatings. In a preferred embodiment, fiber 60 may consist of multiple layers, such as an acrylate, polyimide, aluminum, or gold protective coating, a silica cladding, and a doped or fused silica core. In a preferred embodiment, the actual core of wire 60 may be approximately 10 micrometers. Other optical fibers 60, such as those from Fiberguide Industries of Stirling, N.J., may be utilized in conjunction with the other components illustrated and described.

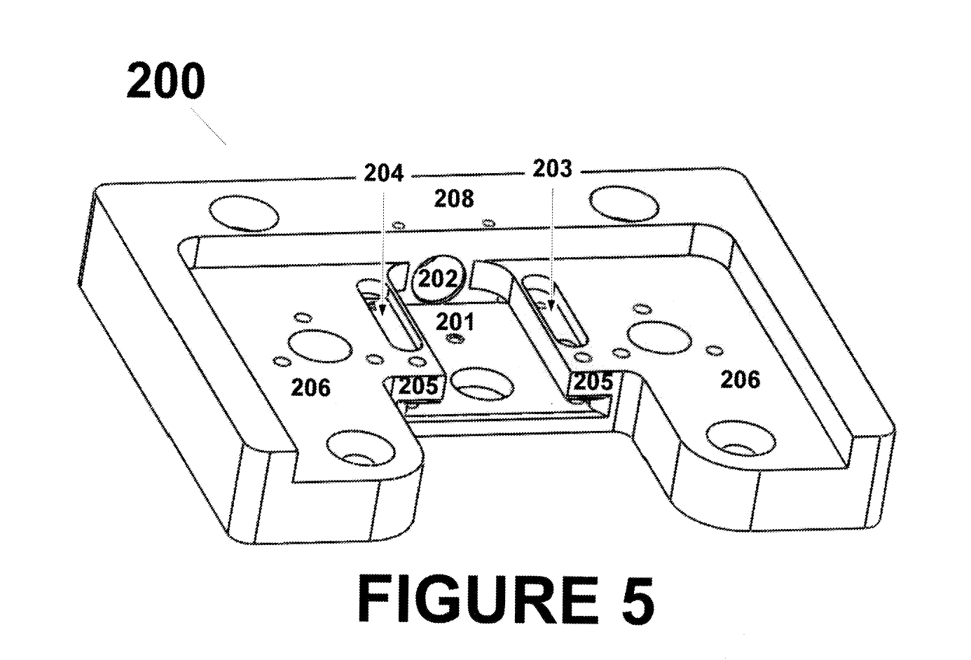

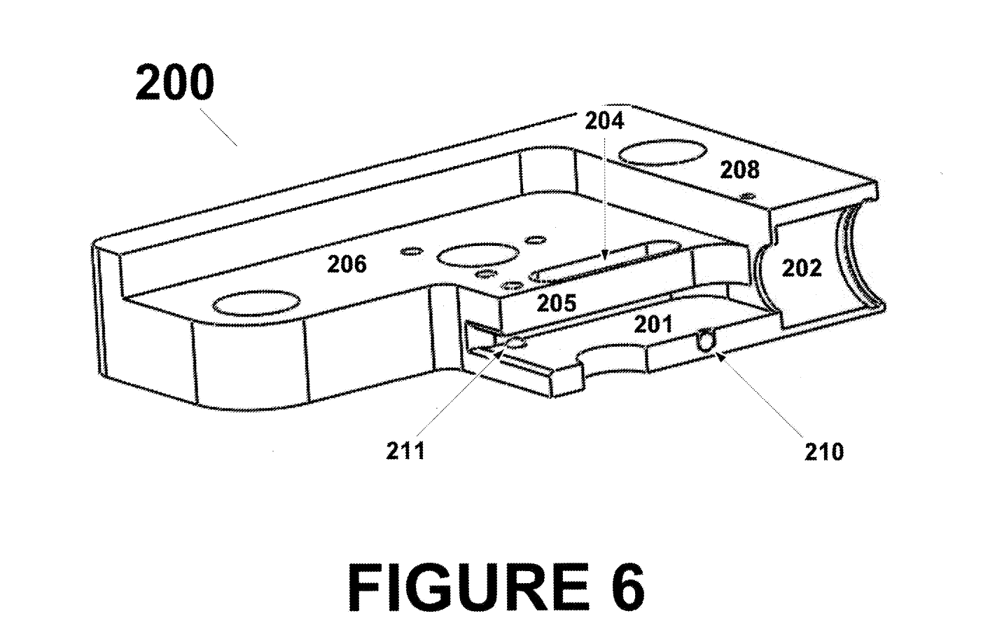

Mount 108 serves to couple the vertical components of modular DFM head 100 to the remainder of the DFM base 200 for operation. Mount 108 may be specifically shaped and sized to slide within DFM base 200 at one or more complementarily shaped coupling points 205. In one embodiment, coupling point 205 permits modular DFM head 100 to snap into place within DFM base 200. Alternatively, coupling point 205 may include ball-and-spring channels that apply repressive force on mount 108 to preclude movement of modular DFM head 100 during operation. Further points of coupling with DFM base 200 may be observed in the embodiments illustrated in FIGS. 5 and 6. As previously discussed, while a slide-in type modular DFM head 100 is illustrated, those skilled in the art would recognize that vertically situated modular DFM head 100 is also capable of use in accordance with the teachings of this disclosure.

While sleeve 109 preferably gives an exemplary modular DFM head 100 assembly the precision mounting suitable for measuring samples, an exemplary forward implementation of an exemplary modular UHV compatible connector DFM head 100 may be an in-line arrangement involving a straight fiber 60 going through body 106 and sensor assembly 101. In a preferred implementation configuration, sleeve 109 may serve as the positioning and mount for the fiber 60. In such instances where modular DFM head 100 may be situated in such a vertical column AFM device, mounts 108 may be cylindrical fins or locks that preclude movement of vertically mountable modular DFM head 100.

A modular DFM head 100 may be made of a material suitable to withstand temperatures of up to 250° C. A modular DFM head 100 would also be composed of a material suitable for use in a vacuum. In a preferred embodiment, modular DFM head 100 may be made of titanium, stainless steel, and aluminum. Alternatively, modular DFM head 100 may be a type of ceramic, such as Silicon Carbide or Alumina. An exemplary modular DFM head 100 is preferably machined. However, DFM head 100 may also be made of plastic compounds which are suitable for use and operation in UHV. As a plastic compound, DFM head 100 may be fabricated by three-dimensional polymer layering techniques (such as stereolithography and other rapid prototyping methods known to those skilled in the art). In another exemplary embodiment, a DFM head unit may also be miniaturized further using micro-machining methods to create an “integrated” DFM head in a chip-like format.

Sensor 101 may contain upper bracket 103 and lower bracket 104 that may coincide at a pivot point 30 where a certain degree of flexibility exists in sensor assembly 101. According to the illustrative embodiment of FIG. 1, pivot point 30 may elastically deform when a force is applied by one or more displacement device 80. According to an exemplary embodiment, displacement device 80 may be a clamp, a screw, or a piezoelectric device. In a preferred embodiment, the displacement device 80 is a screw. Application of a force by displacement of the displacement device 80 may cause bending of sensor assembly 101 at pivot 30.

In an exemplary embodiment, upper bracket 103 of sensor assembly 101 may be integrally coupled to jaw 102. In this example, deflection of upper bracket 103 at pivot point 30 may also deflect jaw 102. It may be understood by those skilled in the art that displacement of upper bracket 103 may controllably displace jaw 102 and its coupled fiber 60. In a preferred embodiment, limited rotational translation of screws 80 on sensor assembly 101 may cause fiber 60 to displace and approach cantilever 54 for more optimal interferometric measurements.

While sensor assembly 101 may be utilized to adjust the positions of fiber 60 in relation to cantilever 54, an exemplary modular DFM head 100 may also contain piezoelectric actuator(s) 105 for moving cantilever base 51. Suitable modular DFM head piezoelectric controller(s) 300 may be situated adjacent piezoelectric actuator 105 or circuitry in and around body 106 and sensor assembly 101 for mobilizing cantilever 54 known to those skilled in the art. Exemplary piezoelectric actuators 105 and controllers 300 may be of the types found in U.S. Pat. No. 5,354,985, the disclosure of which is incorporated herein in its entirety. In a preferred embodiment, compression piezoelectric actuators 105 provide precise Z displacement for interferometer gap tuning and cantilever excitation and control of fiber 60 to pre-align and affix fiber 60 to sensor 101 for interferometer gap adjustments.

Cantilever base 51 may provide horizontal extension of cantilever 54 to adequately measure a sample placed near and around tip 56. In non-contact AFM applications, cantilever base 51 may be equipped with a leaf spring or clamp 53, which may be coupled to cantilever 54 using friction or adhesives. Affixing cantilever base 51 and its related components atop piezoelectric actuator 105 is cantilever mount 50. Cantilever mount 50 acts as an adapter or holder for attachment of cantilever base 51 and cantilever 54. Cantilever mount 50 may be a block of material to which the cantilever 51 attaches. Application of voltage across the piezoelectric actuator 105 provides for adjustments of the fiber 60 and cantilever 54 gap. In one exemplary embodiment, a DC voltage is applied to the piezoelectric actuator to provide fine adjustments to the fiber 60/cantilever 54 gap. In another exemplary embodiment, application of DC and AC modulation may provide excitation to the cantilever 54 to generate an amplitude substantially near the cantilever 54 resonance frequency. Any industry standard AFM cantilever chips, such as ones from Nanoscience Instruments, Inc. of Phoenix, Ariz., may be used in conjunction with the other components illustrated and described.

While piezoelectric actuator 105 may be provided as a solid component, different frequency requirements or higher frequency applications using the described modular UHV compatible DFM head 100 may involve two piezoelectric components 105. In an exemplary embodiment, a two-part piezoelectric actuator 105 may have one piezoelectric actuator for DC excitation and fine-tuned adjustments and another piezoelectric actuator for AC modulation/excitation for achieving optimized cantilever 54 frequencies. In a further embodiment, the AC piezoelectric actuator 105 may be moved from the site of the DC piezoelectric component 105 to avoid sound wave interferences.

While an exemplary transferable modular DFM head 100 as illustrated in FIG. 1 may include configurable components, the burdens of making in situ adjustments of these components on standard DFM head may be avoided due to the modularity provided by the illustrated construct. For example, time and expense of in situ alignment of the sensor assembly 101 may preclude multiple sample measurements in a period of time. More particularly, by allowing for ex situ optical adjustments and subsequent transfer to a DFM already under UHV, these efforts may be avoided.

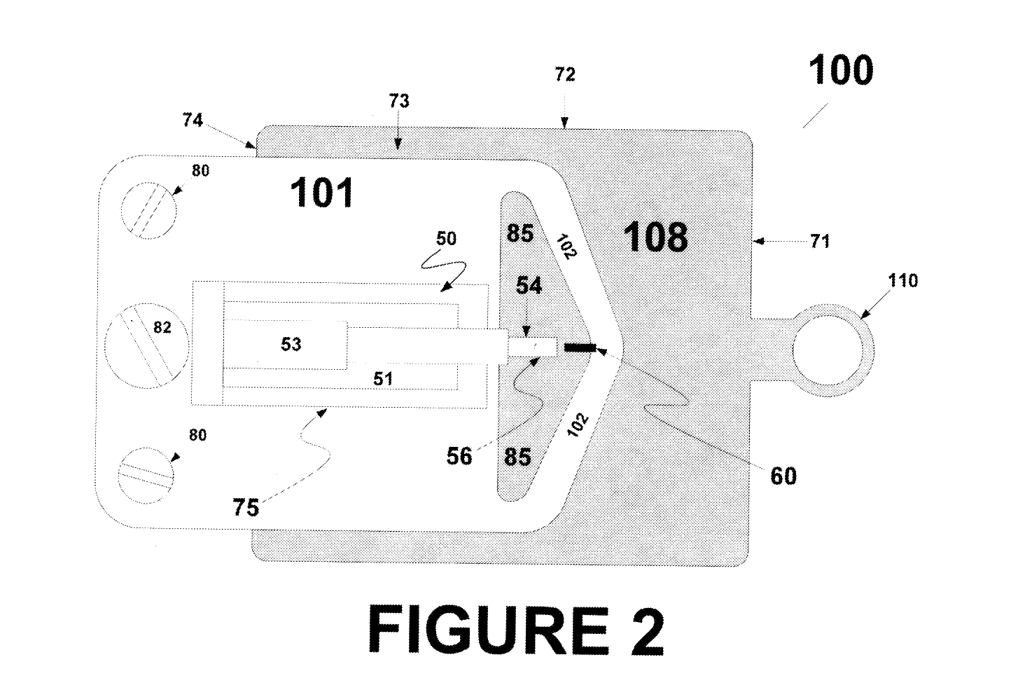

FIG. 2 shows a top plan view of the modular interchangeable DFM head 100. As shown in FIG. 2, sensor assembly 101 is shown with an aperture 75 running through its surface, exposing cantilever mount 50 disposed below cantilever base 51 and above piezoelectric actuator 105, which is used to provide gap adjustments and modulated excitations of cantilever 54. While FIG. 2 illustrates clamp 53 spanning partially the width of cantilever base 51, those skilled in the art may recognize that these sources may be any size and shape to permit desired cantilever adjustments prior to or during measurement activities.

As illustrated in FIG. 2, cantilever 54 extends pin 56 over opening 85 formed by the juncture of jaws 102 and sensor assembly 101. The particular placement and arrangement of cantilever 54 and pin 56 may be adjusted using piezoelectric actuator 105 as is known in the art. Fiber 60 may be prepared optically or otherwise to be situated at a specific interior portion of jaws 102 facing cantilever 54. Depending on the application, fiber 60 may extend towards cantilever 54 or pin 56 to receive measurement signals to be communicated to any AFM/DFM recording utilities known to those skilled in the art. According to an exemplary embodiment of an interchangeable modular DFM head 100, pre-alignment of fiber 60 with cantilever 54 may expedite preparation and recording times for samples measured using AFM/DFM methodologies. Skilled artisans may be able to transfer interchangeable modular DFM head 100 through a UHV chamber to be situated in the DFM base 200 for subsequent sample measurement and reduce time needed to align the various interferometer components in situ.

As illustrated, mount 108 may have any type of geometry with complementarily-shaped receiving surfaces in DFM base 200 (see for example, FIGS. 1, 5, 6, and 7). For example, a mount bracket 110 may be used to screw in or anchor an exemplary interchangeable modular DFM head 100. Alternatively, mount bracket 110 may be a clip, clamp, hook, or magnetic surface. Front mounting surface 71 may abut an inner wall of DFM base 200 allowing modular DFM head 100 to fit snuggly in place to resist movement during operation. Alternatively, mounting front face 71 may receive dampening forces from DFM base 200 to reduce the propensity of modular DFM head 100 from external vibrations.

Like front mounting surface 71, a side mounting surface 72 may also permit sliding engagement of modular DFM head 100 in a DFM base 200 receiving section. As illustrated in FIGS. 1, 5, 6, and 7, DFM base 200 may have a narrow, rectangular receiving section to complement the shapes and thickness of mount 108 and side mounting surfaces 72. It may also be contemplated that side mounting surfaces 72 also contain crevices and geometries for receiving clips, clamps, screws, hooks, or magnetic surfaces to hold modular DFM head 100 in place during operation.

Junction surface 73 may be shaped to allow operative attachment of a preferred modular DFM head 100 to DFM base 200 according to any disclosed embodiments. In a preferred embodiment, junction surface 73 is a right angle. However, those skilled in the art may shape junction surface 73 to reduce vibrations on modular DFM head 100 and fit securely in DFM base 200.

Back mounting surface 74 may be similar to any of the aforementioned mounting surfaces. While sliding attachment of a modular, interchangeable AFM/DFM head 100 is illustrated, a vertically installed interchangeable AFM/DFM head 100 may use back mounting surface 74 to sufficiently couple the head 100 to the vertical column AFC device. In the aforementioned example, back mounting surface 74 may be shaped to have brackets that lock the head device 100 into place when vertically placed within a cylindrical magnetic force microscope.

While the aforementioned mounting surfaces 71 through 73 may be flat, those skilled in the art may consider beveled, chamfered, and other surface variations on mount 108 depending on the particular applications. While mount 108 is shown coupled to tunneled body 106 of an exemplary interchangeable modular DFM head 100, it may be appreciated that mount 108 may be removable from the remainder of device 100 to allow customization of mounting capabilities for a sensor assembly 101.

Also illustrated in FIG. 2 are a set of displacement devices 80. In a preferred embodiment, displacement devices 80 may be screws. As illustrated, controlled rotation of one or both of these displacement devices 80 may balance or adjust the positioning of cantilever 54 and pin 56 in relation to fiber 60.

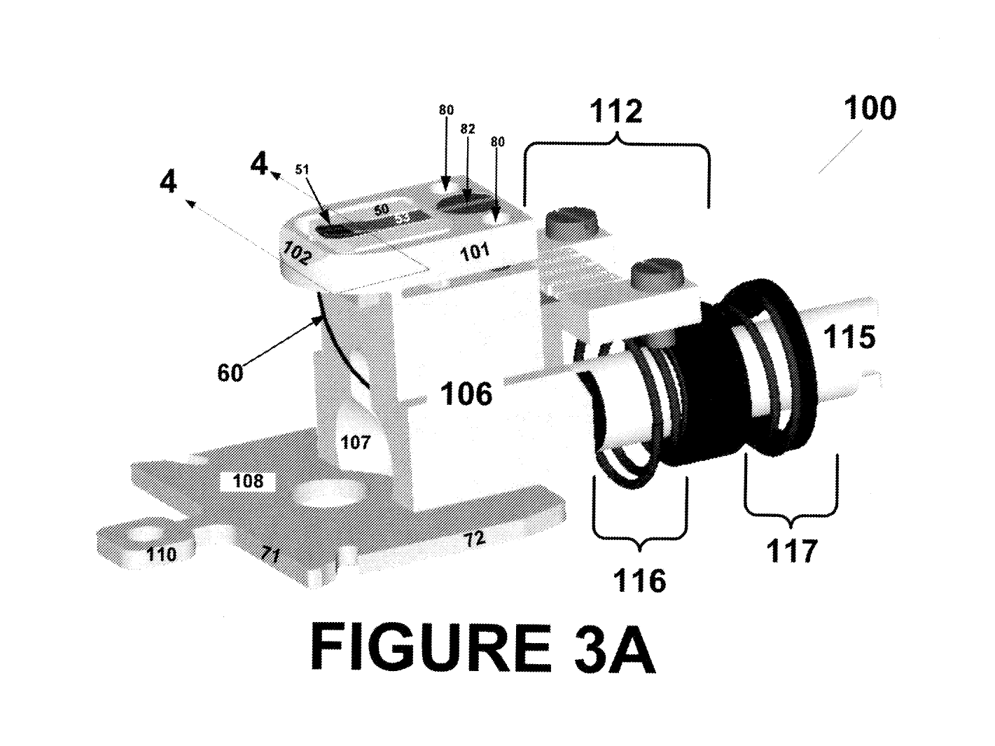

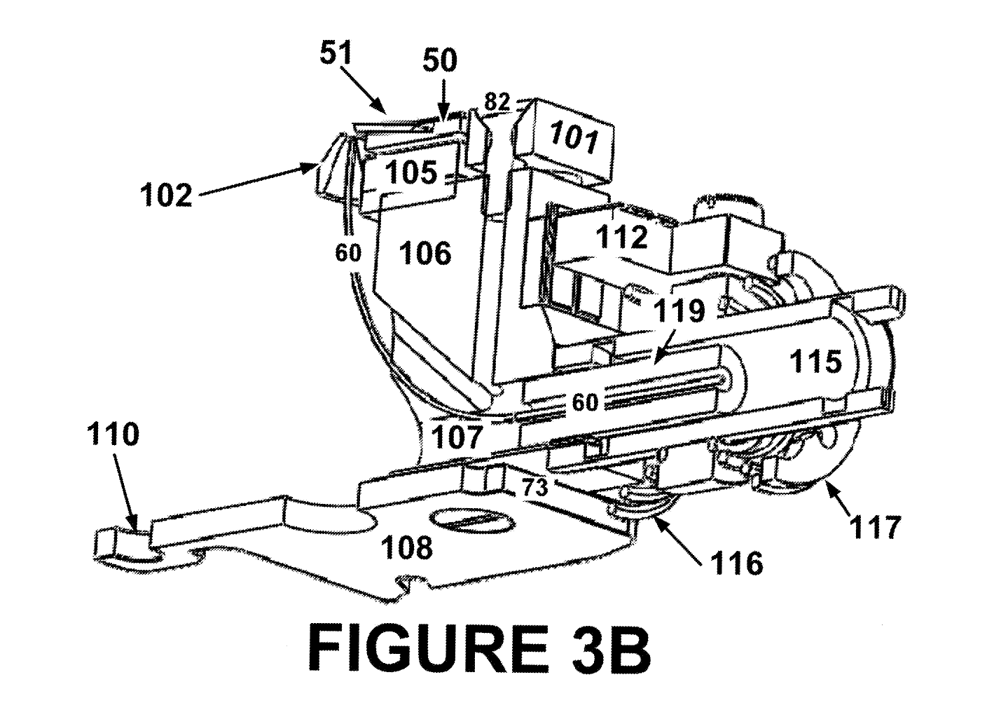

Turning to FIGS. 3A and 3B, a fully assembled modular interchangeable DFM head 100 may be illustrated with further adaptors connected to modular DFM head 100 for assembly in an operative configuration. An exemplary operative configuration of an modular DFM head 100 according to FIGS. 3A and 3B may be seen in FIG. 7. As shown in FIGS. 3A and 3B, a series of adjustment elements made up of displacement device 80 and 82 are located distal to sensor assembly 101 and/or jaws 102. Displacement device 82, like displacement device 80, may, be screws, clamps, or other like adjustment mechanisms, however, in a preferred embodiment, the displacement device 82 is a screw.

Also illustrated in FIGS. 3A and 3B is fiber connector 115 containing angle alignment mechanisms 116 and 117. An exemplary fiber connector 115 may be a standard DMI fiber connector type utilizing an angle polished connection (APC) version with customized clips for maintaining its position. These devices may be used for suspension of fiber 60 from tunnel 107 and through DFM/AFM base 200. Alignment mechanisms 116 and 117 may be springs, but any suitable alignment mechanisms known to those skilled in the art may be used for attachment of a suitable modular interchangeable DFM head 100 to an AFM/DFM base 200. Disposed above fiber connector 115 may be a control panel 112 for sending signals to and from piezoelectric actuators employed within DFM device 100 or external to DFM device 100 depending on the desired operation. It may be conceivable that control panel 112 may provide yet another anchoring component for holding an exemplary DFM device 100 in place for operation.

Referring back to FIG. 1, the fiber connector 115 engages alignment sleeve 109 so as to place the modular end point of fiber 60 (denoted 61 in FIG. 1) in operative contact with fiber 60 end (denoted 62 in FIG. 1) which resides within the larger DFM base 200. As assembled in FIG. 1, the modular device connects a pre-aligned or customizable interferometric sensor with the fiber 60 residing in the remaining parts of the AFM/DFM base 200. According to an exemplary embodiment, the fiber points 61 and 62 are aligned to each other using an industry standard APC fiber connector with rotational alignment notches and a sleeve/ferrule combination for maximum optical signal transmission. In an exemplary embodiment, a customized DMI connector is used for fiber transmission in UHV use. However, skilled artisans may appreciate that the fiber points 61 and 62 may slidingly engage one another at angled ends so as to substantially contact one another to reestablish a unified fiber 60 traveling from the sensor jaws 102 to the internal microscope components of AFM/DFM base 200.

According to the illustrative embodiment of FIGS. 3A and 3B, side surface 72 is not completely flat but is advantageously angled so as to have receptive portions for receipt in complementarily shaped receiving slots of a DFM base 200 (for example, slots 201 and 205 shown in FIGS. 5 and 6). Also illustrated in the illustrative body 106 of interchangeable sensor assembly 100 is a tunnel 107 possessing additional curvatures and channeling to permit greater angular rise of fiber 60 to sensor assembly jaws 102. While an exemplary interchangeable modular DFM head assembly 100 is not limited to any particular fiber 60 angle from tunnel 107 to jaws 102, those skilled in the art may be able to select a proper tunnel 107 based on the fiber 60 required, the application for which the fiber 60 or sensor assembly 101 will be used, and prior alignment requirements for pre-alignment of an exemplary modular DFM head assembly 100.

As illustrated in FIG. 3B, alignment sleeve 119 holds fiber 60 as it exits from tunnel 107 in body 106. In operation, alignment sleeve 119 may be inserted in a fiber connector 115 which provides operative coupling between fiber 60 of the modular transferable fiber interferometer 100 and the AFM/DFM base 200 (see FIG. 1, items 61 and 62). To aid in the coupling of sleeve 119 and connector 115, loading mechanisms such as springs 116 and 117 may be utilized. According to the illustrative embodiment of FIG. 3B, springs 116 and 117 in combination with connector 115 may provide a floating mount for the fiber connector 119 with a slight spring load to maintain connector positioning. It is also illustrated in FIG. 3B, a back mount surface 73 that is substantially perpendicular to sleeve 119 and connector 115. While in the sliding engagement embodiments in this disclosure surface 73 may be substantially perpendicular, it may be understood that mount surface 73 may be shaped in a suitable manner to allow insertion in various atomic force microscopes or magnetic force microscopes. For example, the Omicron (C) sample plate Stullenbrett has a similar ring handle to mount handle 110 and may be used for such purposes as modular implementations of UHV compatible SPM heads.

With reference to cross-section 4-4 in FIG. 3A, FIG. 4 illustrates the cross-section 4-4 an enlarged perspective view. According to the exemplary embodiment illustrated in FIG. 4, a fiber 60 may be shown pointing towards a cantilever 54 and pin 56. Fiber 60 is disposed on or near jaws 102 depending on the application. Cantilever 54 extends outwardly towards jaws 102 from cantilever base 51. Clamp 53 portion of cantilever base 51 leading up to cantilever 54. Cantilever base 51 may be situated atop piezoelectric actuator 105 and may be positioned based on signals sent to and received from the actuator.

FIG. 5 illustrates an isometric view of an exemplary DFM base 200. Coupling arms 205 arch over a slot platform 201 and may contain crevices 203 and 204 for securing a mount for a modular, transferable UHV-compatible DFM head 100. An exemplary slot platform 201 may contain entry points for ball-spring dampeners/clamps to hold a mount of an exemplary modular DFM head 100 in a secure fashion within the DFM base 200. Orifice 202 may serve as a throughway for inserting sleeve 119, sleeve and fiber connector 115, or just fiber 60, depending on the particular needs of the microscope for which modular DFM head 100 is being used. In a preferred embodiment, fiber connector 115 engages sleeve 119 within orifice 202 to lock modular DFM head 100 into DFM base 200 for use in atomic force measuring applications. Body 106 or controllers 300, such as piezoelectric controllers 112, may abut and/or couple to ledge 208. Platform surface 206 may serve as the coupling point for adjustment devices passing through coupling arms 205 or through crevices 203 and 204. In operation, platform surface 206 may serve as a coupling point for other adaptors or components for proper use of the installed modular transferable compatible DFM head 100.

FIG. 6 illustrates a section of the isometric view of DFM base 200 illustrated in FIG. 5. As previously described, slot platform 201 may contain a securing mechanism to maintain stability of modular DFM head 100 during operation and to fix the device in DFM base 200 to avoid misalignments and dampen any motion. Exemplary securing mechanisms may be screw fasteners, springs, washers, or spacers. In a preferred embodiment, the securing mechanism is a ball-and-spring assembly. FIG. 6 illustrates ball-and-spring assemblies 210 and 211 in a compressed state and ready to receive a modular DFM head 100 across their spherical surfaces. While a ball-and-spring assembly is provided, other suitable securing mechanisms are known to those skilled in the art. FIG. 6 further illustrates the crevice 203 through which adjustment devices may be placed and pass through to the mount of an exemplary modular DFM head 100.

FIG. 7 illustrates a modular transferable interferometer device 100 coupled to a DFM base 200 via coupling slot 201, through crevices 203/204, and on ledge 208. As shown, modular DFM head 100 is made up of sensor 101, body 106, and mount 108. Mount 108 has been slidingly inserted within DFM base 200 through slot 201 and held in secured formation by a combination of securing mechanisms (not shown) and coupling arms 205. Further securing of the modular device 100 is illustrated at points 203/204 where adjustment devices 209 pass through platform 206 and into peripheral edges of mount 108 (not shown). Further securing the module device 100 to DFM base 200 is piezoelectric controller 112 and its coupling with ledge 208. As oriented, fiber 60 faces outwardly from the ledge 208 as it travels from sensor 101 through body 106 and through the orifice 202 of DFM base 200 (not shown). While this embodiment illustrates a sliding engagement between modular DFM head 100 and AFM/DFM base 200, other engagements between modular DFM devices may be understood with reference to these disclosures.

As illustrated in these embodiments, an exemplary interchangeable modular DFM head assembly 100 with sensor assembly 101 provides for ex situ alignment of various components, in particular, the fiber 60, which often may be difficult to accomplish in UHV. As the fiber 60 can be transferred with an entire exemplary DFM device 100, the entire DFM assembly 100 can be pre-aligned and tested ex situ.

The modular or “plug-and-play” capabilities of an exemplary DFM device 100 may offer numerous pre-aligned modular DFM heads for various atomic measurement applications for ready use and re-use. In another aspect of the exemplary embodiments disclosed, alignment stations may be used for pre-alignment and testing of interchangeable interferometer heads. While use of the disclosed modular DFM device 100 has practical applications in UHV experiments, it may be used in other AFM-type measurement schemes, such as biological measurements, regular AFM tapping modes, and ambient measuring of samples.

It is to be understood that the above description is intended to be illustrative, and not restrictive. Many other embodiments will be apparent to those of skill in the art upon reviewing the above description and interrelated disclosures of the various disclosed embodiments and figures. Indeed, those skilled in the art will recognize, or be able to ascertain using no more than routine experimentation, many equivalents to the specific embodiments described. Such equivalents are intended to be encompassed by the following claims. The scope of the invention should, therefore, be determined with reference to the appended claims, along with the full scope of equivalents to which such claims are entitled.

1. A modular fiber connector device, comprising:
a body having a tunnel extending therethrough;
an interferometric sensor assembly disposed vertically above the body and comprising a brace extending in the direction distal from the end of the tunnel and circumscribing an opening through which a first optical fiber extends, the first optical fiber traveling through the tunnel;
a cantilever extending from the interferometric sensor assembly and over the opening, the cantilever being configured for alignment with the first optical fiber; and
a mount for coupling the first optical fiber with a second optical fiber disposed within an atomic force measurement apparatus for measuring atomic forces.

2. The device of claim 1, wherein the brace is configured to hold the first optical fiber.

3. The device of claim 1, wherein the mount extends in the same direction as the brace.

4. The device of claim 1, further comprising a sleeve coupled to the tunnel in which the first optical fiber is aligned.

5. The device of claim 1, further comprising an aperture in the brace through which a piezoelectric actuator is disposed between the interferometer-type cantilever and the body.

6. The device of claim 3, wherein the mount extends from the body in a direction perpendicular to the tunnel.

7. The device of claim 5, wherein the interferometric sensor assembly further comprises alignment devices for aligning the cantilever and first optical fiber.

8. The device of claim 7, wherein the alignment devices comprise one of a screw or a piezoelectric sensor.

9. The device of claim 3, wherein the mount is configured to attach to the atomic force measurement device using a screw, a ball-and-spring mechanism, or a frictional engagement.

10. The device of claim 1, wherein the body is fabricated from the group consisting of titanium, stainless steel, aluminum, and silicon carbide.

11. The device of claim 1, wherein the first optical fiber comprises a polyimide coating.

12. The device of claim 1, wherein the first optical fiber and the cantilever are pre-aligned for use in an atomic force measurement apparatus under vacuum.

13. A method of installing a modular fiber connector, comprising:
aligning a first end of a first optical fiber with a cantilever, the first end of the first optical fiber extending through an opening in a sensor assembly disposed vertically above a body and a second end of the first optical fiber passing through a tunnel in the body, the cantilever extending from the sensor assembly over the opening through which the first optical fiber extends; and
configuring the body for insertion into a microscope so that the second end of the first optical fiber operatively connects to a second optical fiber coupled to the microscope.

14. The method of claim 13, further comprising inserting the body into the microscope so that the second end of the first optical fiber operatively connects to the second optical fiber coupled to the microscope.

15. The method of claim 13, wherein aligning includes adjusting a brace coupled to the sensor assembly to displace one of the cantilever and the first optical fiber.

16. The method of claim 15, wherein adjusting comprises one of rotating a screw or operating a piezoelectric transducer.

17. The method of claim 13, wherein configuring further comprises coupling the body to a mount for inserting into a microscope.

18. The method of claim 17, wherein the mount is configured for sliding engagement of the body into the microscope.

19. The method of claim 18, wherein the mount is configured for the vertical insertion of the body into the microscope.

20. The method of claim 13, wherein configuring the body includes placing a sleeve over the second end of the first optical fiber.
